(19) United States
(12) Patent Application Publication
(10) Pub. No.: US 2005/0016392 A1
(43) Pub. Date: Jan. 27, 2005

(54) Disposable butter dispenser

(76) Inventor: Levi Gil Shoshan, Wellington, FL (US)

Correspondence Address: RUDEN, MCCLOSKY, SMITH, SCHUSTER & RUSSELL, P.A., P.O. BOX 1900, FORT LAUDERDALE, FL, 33301, US

(21) Appl. No.: 10/895,602

(22) Filed: Jul. 21, 2004

Related U.S. Application Data
(60) Provisional application No. 60/489,857, filed on Jul. 24, 2003.

(51) Int. Cl. A23B 4/12

(52) U.S. Cl. 99/516

(57) ABSTRACT

A disposable container/applicator for dispensing a spreadable food item, said dispenser comprising a housing, adapter, base screw and piston wherein said piston travels longitudinally towards said dispensing end and said base screw is rotated in a first direction and includes at least one aperture to permit the passage of a spreadable product.

### CROSS-REFERENCE TO RELATED APPLICATIONS

This application claims the benefit of U.S. Provisional Application Ser. No. 60/489,857, filed on Jul. 24, 2003, entitled DISPOSABLE BUTTER DISPENSER.

### TECHNICAL FIELD OF THE INVENTION

The present invention relates to food containers and applicators. More particularly the present invention relates to a container/applicator for dispensing a spreadable food item such as butter or margarine.

### BACKGROUND OF THE INVENTION

Traditionally, to apply butter to a piece of food a knife is used to cut the butter from the stick and spread it on the food. For food such as corn-on-the-cob, the butter has a tendency to slip off of the corn and knife while being spread. For other food, such as toasted bread, the pressure exerted by the knife may crush the bread or contact between the knife and bread may tear the bread.

Accordingly, to address these and other problems, the container art has many examples of containers for storing and dispensing semi-soft sticklike products, such as butter or oleomargarine. See, for example, the devices disclosed in U.S. Pat. Nos. 2,980,247, 3,162,884 and 3,374,048. All of these devices are intended to make dispensing of such products easy and efficient. a number of butter dispensing devices have been proposed.

Bordwine, et al., U.S. Pat. No. 3,162,884, discloses a telescoping butter dispenser having inner and outer telescoping housing members and a multi-component plunger system for forcing the butter out of the dispenser. Inwardly projecting bosses are formed adjacent the dispenser outlet to prevent the butter from exiting the dispenser until sufficient force has been applied to extrude the butter past the bosses. To fully dispense the stick of butter, the user must change the plunger configuration when the butter has been partially dispensed.

Deitz U.S. Pat. No. 4,964,745 discloses a butter dispenser wherein a wire extends across the dispenser outlet. The wire serves to retain the butter in the dispenser until sufficient force is applied to force the butter around the wire so that the wire cuts the stick of butter in two.

While such devices often work well, they still have deficiencies that inhibit their full commercial acceptance. For example, these devices are often difficult to use and control. The pressure required to force the butter out of the container may simply be too great for particular a person, and the known dispensers simply are not amenable to efficient and comfortable operation using two hands.

A still further drawback to many such known dispensers is the difficulty associated with the cleaning thereof. Because of the tubular nature of those dispensers, a cleaning device or tool must be inserted into the tubular container and manipulated to effect the full cleaning of the inside surfaces of the container. Insertion and manipulation of such cleaning tools may be difficult for some people whereby all internal surfaces of the container are not fully cleaned in all situations.

Thus, there is a need for a butter dispenser that is simple to make and use, which adequately retains the butter within the dispenser, allows for butter to shaved off of the butter product so as to be spreadable while cold, and is disposable.

### SUMMARY OF THE INVENTION

The present invention eliminates the above-mentioned needs for a butter dispenser by providing a disposable butter dispenser that dispenses a spreadable product by rotating a base screw to revolve a piston supporting a spreadable product, the revolving piston traveling both longitudinally and axially so as to shave off spreadable product through holes in the dispenser's housing.

In accordance with the present invention, there is provided a disposable butter dispenser including a housing having a base end and a dispensing end, a base adapter secured to the base end, a base screw operationally engaged to the base adapter, and a piston rotatably mounted to said base screw.

### BRIEF DESCRIPTION OF THE FIGURES

FIG. 1 is a side view illustration of the preferred embodiment of the present invention.

FIG. 2 provides illustrations of the components of the preferred embodiment.

### DETAILED DESCRIPTION OF THE PREFERRED EMBODIMENT

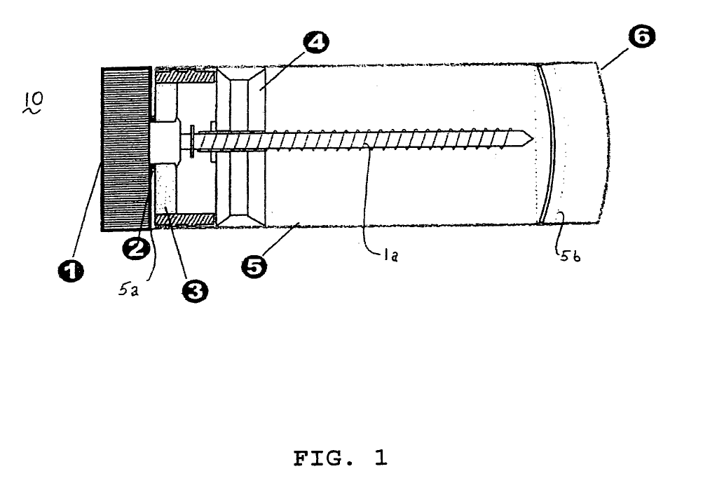

Referring now to FIG. 1, the preferred embodiment of the present invention is shown as disposable butter dispenser 10. Disposable butter dispenser 10 includes a housing 5 having a base end 5a and a dispensing end 5b, a base adapter 3 secured to base end 5a, a base screw 1 operationally engaged to base adapter 3, and a piston 4 rotatably mounted to base screw 1.

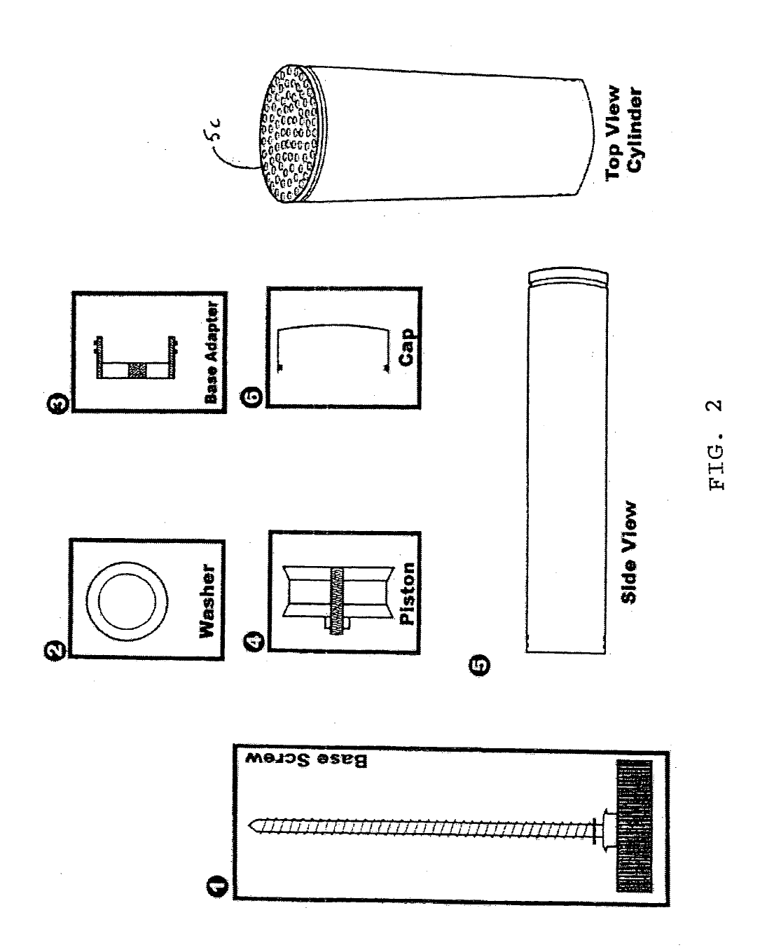

Housing 5 may be formed of a variety of materials, including various polymers, paper products, and the like. Although it is preferred that housing 5 be cylindrical in cross section, it is contemplated that other cross-sectional shapes can be incorporated. Housing 5 has apertures 5c, shown in FIG. 2, positioned on dispensing end 5b. Apertures 5c provide shaving or cleaving points, so that a spreadable product, such as butter, can be taken off of the spreadable product while the spreadable product is cold, yet still allowing the portion removed to be spread on a substrate, such as bread. Housing 5 additionally includes base end 5a, which secures base adapter 3.

Base adapter 3 operationally engages base screw 1. Base screw 1, in the preferred embodiment passes through base adapter 3 and into an area internal to housing 5. A washer 2 can be used to prevent base screw 1 from contacting base end 5a. Piston 4 is positioned on base screw 1 so that as base screw 1 is rotated, piston 4 travels longitudinally while simultaneously rotating axially along a treaded portion 1a of base screw 1.

The longitudinal travel and simultaneous axial rotation of piston 4 cause the spreadable product (not shown) to also travel longitudinally while axially rotating. These simultaneous motions of the spreadable product cause a portion of the spreadable product in contact with apertures 5c to be shaved or cleaved off from the remaining spreadable product. Apertures 5c can be shaped so as to efficiently effectuate shaving, cleaving, or grating of the spreadable product. It is preferred that apertures 5c be provided with a shape that permits less than the entire circumference of the portion of an aperture in initial contact with the spreadable product to shave, cleave, or grate the spreadable product, much like the graters of a cheese grater.

Piston 4 is mounted on base screw 1 so that as base screw 1 is rotated, piston 4 travels longitudinally along the inside of housing 5, forcing the spreadable product contained inside housing 5 towards dispensing end 5b. Piston 4 is threaded complementary to base screw 1. Rotating base screw 1 turns the spreadable product in a manner corresponding to the rotation of piston 4. Depending upon the temperature of the spreadable product, as base screw 1 is rotated to advance the spreadable product, resistance encountered as the product contacts dispensing end is translated into heat generated by friction, reducing the solidity of the already semi-solid spreadable product and preventing excessive forces resulting from compression of the spreadable product from pushing piston 4 downward against threads 1a. It is contemplated that should a limiting force condition is reached, piston 4 can include additional structures so as to sufficiently prevent further rotation of piston 4 and thus further advancement of the spreadable product.

Additionally, cap 6 may be provided to cover apertures 5c so as to retard spoilage of the spreadable product. Once the entire spreadable product is dispensed, the user simply discards dispenser 10.

Although only a few exemplary embodiments of the present invention have been described in detail above, those skilled in the art will readily appreciate that numerous modifications are to the exemplary embodiments are possible without materially departing from the novel teachings and advantages of this invention. Accordingly, all such modifications are intended to be included within the scope of this invention as defined in the following numbered claims and accompanying drawings.

1. A disposable butter dispenser, comprising:
a housing having a base end and a dispensing end;
a base adapter secured to said base end;
a base screw operationally engaged to said base adapter; and
a piston rotatably mounted to said base screw.

2. A disposable butter dispenser, comprising:
a cylindrical housing having a base end and a dispensing end;
a base adapter secured to said base end;
a base screw operationally engaged to said base adapter;
a piston rotatably mounted to said base screw; and
wherein said dispensing end includes at least one aperture to permit the passage of a spreadable product.

3. The disposable butter dispenser according to claim 2, wherein said piston travels longitudinally towards said dispensing end when said base screw is rotated in a first direction.

4. The disposable butter dispenser according to claim 2, wherein said piston rotates said spreadable product when said base screw is rotated in a first direction.

5. The disposable butter dispenser according to claim 2, wherein less than an entire circumference of said at least one aperture is in initial contact with said spreadable product.

6. The disposable butter dispenser according to claim 2, wherein said at least one aperture shaves or cleaves off a portion of said spreadable product.
